(19) United States
(12) Patent Application Publication
(10) Pub. No.: US 2009/0202288 A1
(43) Pub. Date: Aug. 13, 2009

(54) Dispenser of coating material

(76) Inventor: Ralph K. Koschinsky, Sandy, UT (US)

Correspondence Address: Kent S. Burningham, Esq.;KENT S. BURNINGHAM, P.C., 466 South 500 East, Salt Lake City, UT, 84102, US

(21) Appl. No.: 12/069,246

(22) Filed: Feb. 7, 2008

(51) Int. Cl. B43K 5/14

(52) U.S. Cl. 401/133

(57) ABSTRACT

Between the closed and open ends of a receptacle is a barrier traversable by a coating material. The barrier separates the receptacle into a coating material reservoir at the closed end and a receiving pocket at the open end configured to enclose an applicator of the coating material or an article to be covered with the coating material. The open end has a selectively resealable closure. A lower compartment and an upper compartment with a selectively resealable upper end communicate through a sieve traversable by the coating material and impassable to applicator or article. A flexible front wall is continuously sealed to a flexible back wall along a contiguous series of edges that terminates in spaced-apart ends on opposite sides of an opening into an interior space between the front and back walls in which a sieve secures the front and back walls.

### BACKGROUND

A. Technical Field

The present invention relates generally to systems and methods for covering an article with a coating material. More particularly, the present invention pertains to a dispenser for a coating material that is applied as a liquid or as a powder to the exterior of an article, either directly by the dispenser, or indirectly by an applicator associated with the dispenser.

B. Background of the Invention

Many are the situation in which an individual is required to cover an article with a coating material that takes the form of a liquid or a powder.

Polishes, cleansers, sanitizers, lubricants, and protective coverings are routinely applied to the exterior of familiar articles, such as furniture, work surfaces, vehicles, machinery, and implements of diverse types ranging from surgical equipment to kitchen utensils and garage tools. Lotions, oils, sunscreens, and antiseptics are regularly used as coating materials to cover the skin or hair of persons or the hides and fur of pets and livestock.

Often such processes are wasteful of the coating material employed. The utility of large quantities of coating material is squandered, when that coating material becomes dispersed onto the hands or clothing of a user or is distributed inadvertently into the air or onto incidental surfaces in the environment in which the application of the coating material is undertaken. Applicators saturated by or laden with coating material are frequently discarded after use, without consideration being given to the loss occasioned thereby of potentially useful coating material.

### SUMMARY OF THE INVENTION

The present invention facilitates the covering of articles with liquid and powdered coating materials. In so doing, the present invention contributes to user convenience, workplace orderliness, and the conservation of coating materials.

Thus, in one aspect of the present invention, a dispenser for a coating material is provided that segregates from the general environment the article being covered by the coating material.

The present invention provides such a dispenser in which any coating material not retained on the article being covered is conserved for future use.

In another aspect of the present invention, an applicator of a coating material becomes saturated or laden with a coating material in a confined environment, and coating material not retained on the applicator is conserved for future use.

The present invention also provides for the secure confinement of a supply of a coating material before and following use of the coating material to cover an article or to saturate or laden an applicator.

In some embodiments of the present invention, secure confinement is provided for an applicator of a coating material, and the applicator may, therefore, be reused on successive occasions.

Additional objects and advantages of the invention will be set forth in the following description, and in part will be obvious from the description, or may be learned by the practice of the invention. The objects and advantages of the invention may be realized and obtained by means of the instruments and combinations particularly pointed out in the appended claims.

### BRIEF DESCRIPTION OF THE DRAWINGS

Reference will be made to embodiments of the present invention, examples of which will be illustrated in the accompanying figures. These figures are intended to be instructive, rather than limiting. Although the present invention is generally described in the context of those embodiments, the scope of the present invention is not limited to the particulars observable in those embodiments.

FIG. 1 illustrates a first embodiment of a dispenser incorporating teachings of the present invention in the dispenser is employed by a user to cover the exterior of an automotive vehicle with a coating material;

FIG. 2 is a perspective view of the dispenser of FIG. 1 and an applicator in the open end of the dispenser;

FIG. 3 is a cross-sectional front elevation view of the dispenser of FIG. 2 taken along section line 3-3 shown therein;

FIG. 4 is a cross-sectional side elevation view of the dispenser of FIG. 2 taken along section line 4-4 shown therein;

FIG. 5A is a cross-sectional plan view of the dispenser of FIG. 2 taken along section line 5A-5A shown therein;

FIG. 5B is an enlarged detail view of a correspondingly identified portion of FIG. 5A showing a first embodiment of an interior construction aspect of a dispenser configured according to teachings of the present invention;

FIG. 6 is a view like that presented in FIG. 5B showing a second embodiment of an interior construction aspect of a dispenser configured according to teachings of the present invention;

FIG. 7 is a view like that presented in FIG. 5B showing a third embodiment of an interior construction aspect of a dispenser configured according to teachings of the present invention;

FIG. 8 is a view like that presented in FIG. 5B showing a fourth embodiment of an interior construction aspect of a dispenser configured according to teachings of the present invention;

FIG. 9 is a perspective view of a second embodiment of a dispenser incorporating teachings of the present invention;

FIG. 10 is a cross-sectional front elevation view of the dispenser of FIG. 9 taken along section line 10-10 shown therein;

FIG. 11 is a cross-sectional side elevation view of the dispenser of FIG. 9 taken along section line 11-11 shown therein;

FIG. 12 is a cross-sectional plan view of the dispenser of FIG. 9 taken along section line 12-12 shown therein;

FIG. 13 is a perspective view of a third embodiment of a dispenser incorporating teachings of the present invention and a cut of meat in the open end of the dispenser;

FIG. 14 is a cross-sectional front elevation view of the dispenser of FIG. 13 taken along section line 14-14 shown therein;

FIG. 15 is a cross-sectional side elevation view of the dispenser of FIG. 13 taken along section line 15-15 shown therein; and

FIG. 16 is a cross-sectional plan view of the dispenser of FIG. 13 taken along section line 16-16 shown therein.

### DETAILED DESCRIPTION OF EMBODIMENTS OF THE INVENTION

In the following description of embodiments of the present invention, various specific details are set forth to facilitate an understanding of the teachings of the present invention. The present invention may, however, be practiced without some or all of those details. The embodiments of the present invention illustrated or described herein may be incorporated into a number of different systems and may find utility in a wide variety of circumstances. Structures and devices shown are illustrative of exemplary elements of embodiments of the present invention and are not included so as to afford detractors pretexts by which to attempt to obscure any broad teachings of the present invention. Furthermore, connections between components within the figures are not intended to be limited to direct connections. Rather, connections between components may be modified, reconfigured, or otherwise changed by the interposition of intermediary components.

The use in the specification of the expressions “one embodiment” or “an embodiment” indicates that a particular feature, structure, characteristic, or function described in connection with the inventive embodiment being discussed is included in at least one embodiment incorporating at least some of the teachings of the present invention. The use of the phrase “in one embodiment” in various locations in the specification does not necessarily constitute a plurality of references to a single embodiment of the present invention.

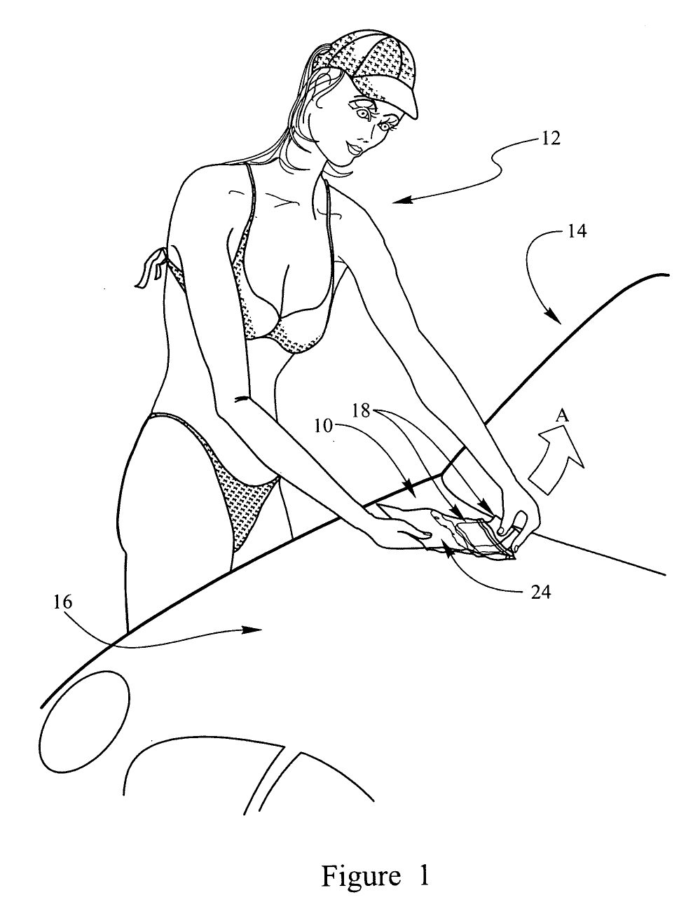

FIG. 1 shows a first embodiment of a dispenser 10 incorporating teachings of the present invention. A user 12 is in the process of maintaining the exterior of an automotive vehicle 14 by covering the outer surface of body 16 thereof with a coating material that is contained in dispenser 10. As suggested by arrow A, user 12 is withdrawing from dispenser 10 an applicator 18 that carries a quantity of the coating material. Once applicator 18 is free of dispenser 10, the quantity of the coating material carried by applicator 18 is transferred by user 12 to the outer surface of body 16 of vehicle 14. Applicator 18 is then employed by user 12 to distribute and work the coating material on the outer surface of body 16. When the quantity of the coating material carried by applicator 18 is exhausted, applicator 18 may be returned to dispenser 10 by user 12 to renew applicator 18 with a fresh quantity of the coating material. When a sufficient quantity of the coating material has been transferred onto the outer surface of body 16 of vehicle 14, and that quantity of the coating material has been satisfactorily distributed onto and worked on the outer surface of body 16 of vehicle 14 by user 12, applicator 18 and any remaining coating material are stored in dispenser 10 awaiting a future use.

The coating material in dispenser 10 may be a powder or a liquid, depending on the intended purpose thereof. Applicator 18 becomes saturated by a liquid coating material or laden with a powdered coating material while applicator 18 is inside of dispenser 10. Coating material in excess of that deemed useful in or on applicator 18 is removed from applicator 18 by user 12 by wringing or shaking applicator 18 while applicator 18 is yet enclosed by applicator 18. Any such excess coating material that is shed from applicator 18 in this manner is accordingly captured inside dispenser 10 and retained there for possible future use. In the context of maintaining the exterior of vehicle 14, the coating material in dispenser 10 is likely to be a liquid, such as a cleaner, a polish, or a wax.

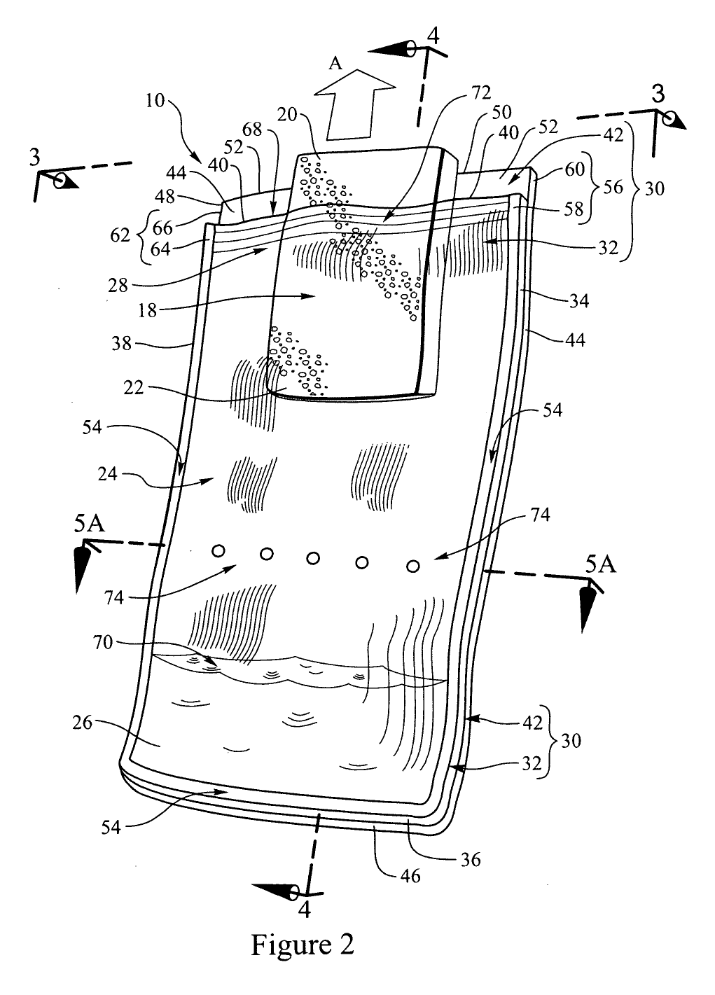

The structure and use of dispenser 10 will be more thoroughly understood by reference to FIG. 2. There, dispenser 10 appears in enlarged perspective with applicator 18 in the process of being withdrawn therefrom in the manner suggested by arrow A. The portion of dispenser 10 interposed between applicator 18 and a viewer of FIG. 2 is transparent, whereby it is possible to observe that while a first end 20 of applicator 18 is outside of dispenser 10, a second end 22 of applicator 18 is interior of dispenser 10. The entirety of dispenser 10 may be similarly transparent. Alternatively, dispenser 10 may be translucent or opaque in whole or in part without departing from teachings of the present invention.

Although applicator 18 can assume a variety of non-planar configurations and shapes, as seen in FIG. 2, applicator 18 is a planar pad of rectangular shape that is made of a porous material suited to the efficient transport from dispenser 10 of the coating material housed therein. Thus, applicator 18 may be made from fiber, sponge, fabric, paper, or a natural or synthetic wicking or dusting material. Applicator 18 is optionally supplied from the manufacturer with or in dispenser 10. In the alternative, applicator 18 can be selected by an ultimate user of dispenser 10, such as user 12 in FIG. 1.

Dispenser 10 assumes the from of a receptacle 24 having a closed end 26 and an open end 28 remote therefrom through which applicator 18 can be entered into or removed from dispenser 10. Receptacle 24 may be endowed with various degrees of rigidity depending on the nature of the coating material to be dispensed therefrom. Nonetheless, as presented in FIG. 2, receptacle 24 comprises a continuous encircling sidewall 30 that extends between closed end 26 and open end 28 of receptacle 24.

A sidewall, such as sidewall 30, in a coating material dispenser incorporating teachings of the present invention takes the form of a unitary sleeve of material that is permanently sealed at one end thereof to create a sack with an open end. Alternatively, the sidewall may also take the form of a front wall and a back wall that are contiguous portions of a unitary sheet of material. The sheet of material is folded between the front wall and the back wall, bringing the front wall and the back wall into a parallel abutment, following which a sealing attachment is effected between various of the opposed peripheral edges of the front wall and the back to produce a receptacle, such as receptacle 24, having a closed end and an open end remote therefrom. In both constructions, the walls of receptacle 24 will be made of the same material possessed of the identical physical properties, such as flexibility, vapor permeability, and opacity.

Alternatively, as shown in FIG. 2, sidewall 30 includes a flexible front wall 32 having a first side edge 34, a lower edge 36, a second side edge 38, and an upper edge 40 attached to a back wall 42 that is, at least initially, a distinct structure from front wall 32. Back wall 42 includes a first side edge 44, a lower edge 46, a second side edge 48, and an upper edge 50, and back wall 42 is substantially coextensive with front wall 32. In this construction, the physical properties of front wall 32 and back wall 42 can be chosen independently of each other. Thus, for example, front wall 32 can be extremely flexible, entirely transparent, and fully vapor impermeable, while back wall 42 is as vapor impermeable as front wall 32, but less flexible and completely opaque.

A short flap 52 of back wall 42 extends beyond upper edge 40 of front wall 32 at open end 28 of receptacle 24. Nonetheless, flap 52 does not detract from what is characterized above as a substantially coextensive relationship existing between front wall 32 and back wall 42 in a dispenser incorporating teachings of the present invention. Similarly, portions of front wall 32 other than at open end 28 of receptacle 24 can be larger or smaller in extent than the correspondingly opposed portions of back wall 34, and front wall 32 and back wall 34 while still being substantially coextensive within the context of the present invention. For example, back wall 42 may be a relatively rigid planar substrate to which a larger, but very flexible front wall 32 is secured to form an expansive open-ended pouch mounted on a supportive backing.

A continuous attachment seal 54 is created between front wall 32 and back wall 34 along a contiguous series of respective edges of each. Attachment seal 54 can be created by continuous heat or ultrasonic tacking, by adhesive attachment, by continuous stitching, or by uninterrupted crimping.

Thus, first side edge 34 of front wall 32 is sealed to first side edge 44 of back wall 42, while lower edge 36 of front wall 32 is sealed to lower edge 46 of back wall 42, and second side edge 38 of front wall 32 is sealed to second side edge 48 of back wall 42. An upper end 58 of first side edge 34 of front wall 32 and an upper end 60 of first side edge 44 of back wall 42 together form a first end 56 of attachment seal 54. Similarly, an upper end 64 of second side edge 38 of front wall 32 and an upper end 66 of second side edge 44 of back wall 42 together form a second end 62 of attachment seal 54. In this manner, defined between first end 56 and second end 62 of attachment seal 54 is an opening 68 at open end 28 of receptacle 24 through which access is securable to an interior space within receptacle 24 between front wall 32 and back wall 34.

For circumstances like those served by dispenser 10, front wall 32 and back wall 42 of sidewall 30 of receptacle 24 are made from thin thermoplastic sheeting and are about 5.0 inches wide and 9.0 inches tall. By way of example, composite sheeting that includes a 0.4 millimeters thick layer of aluminum sandwiched between respective 2.0 millimeter and 1.5 millimeter layers of high density polypropylene provides a secure moisture barrier for coating material 70 and functions well as front wall 32 and back wall 42. Also useful as front wall 32 and back wall 42 are any of various types of biaxially-oriented polyethylene terephthalate polyester film, such as Mylar® brand film manufactured by DuPont Teijin Films U.S. Ltd. of Hopewell, Va., U.S.A. Gusset 126 is installed in receptacle 24 about 4.0 inches from closed end 26 thereof. Optionally, coating material 70 and applicator 18 are provided in receptacle 24 by the manufacturer. Applicator 18 is a square absorbent pad of approximately 4.0 inches on a side.

The portion of receptacle 24 adjacent to closed end 26 thereof houses a supply of a coating material 70 that is shown, by way of example, to be a liquid. A selectively resealable closure 72 is provided at open end 28 of receptacle 24. Using closure 72, receptacle 24 may be sealed at the discretion of a user to prevent the escape of coating material 70, even when receptacle 24 is inverted from the orientation thereof shown in FIG. 2. Closure 72 is capable of being selectively reopened nondestructively afford access to the interior of receptacle 24 and to coating material 70. A closure, such as closure 68, may take the form of resilient, mechanically-mating structures on opposing portions of sidewall 30 that traverse open end 28 of receptacle 24. Alternatively in specific applications, flaps, snaps, zippers, drawstrings, adhesive surfaces, or cooperating mechanical loop-and-hook systems may also serve as effective closures in a coating material dispenser configured according to teachings of the present invention.

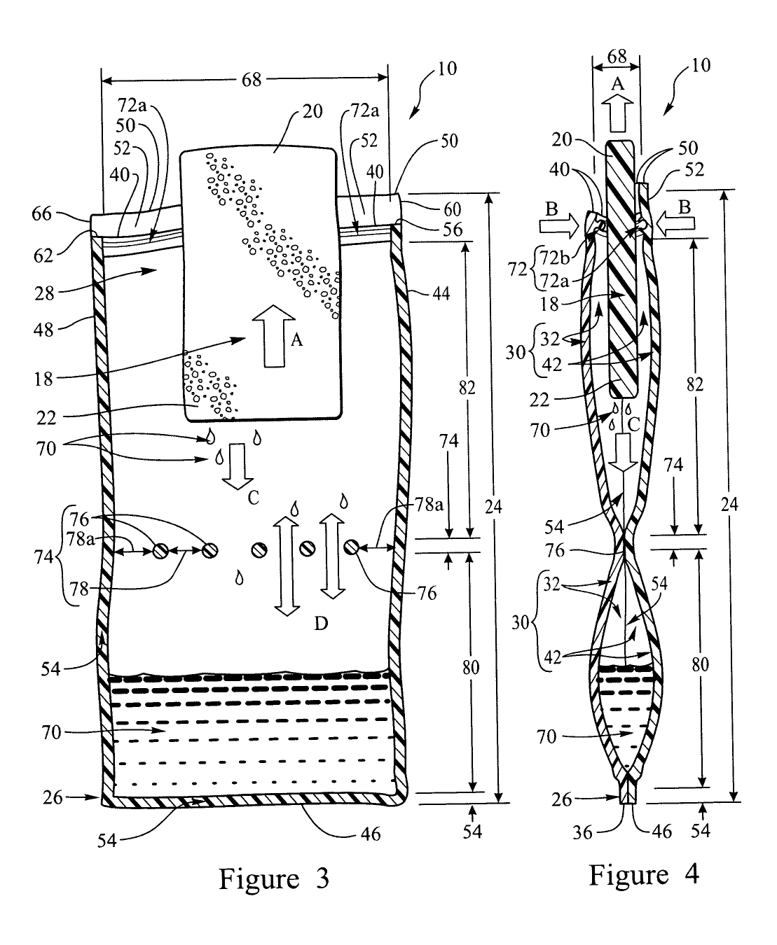

The interior structure of receptacle 24 of dispenser 10 will be explored initially relative to the elevation cross-sectional views of receptacle 24 presented in FIGS. 3 and 4 taken together. There front wall 32 and back wall 42 can be seen to be attached together along attachment seal 54, to produce an open-ended sack-like structure. The space interior of that structure is accessed between first end 56 and second end 62 of attachment seal 54 through opening 68. In FIGS. 3 and 4, opening 68 is partially occupied by applicator 18, which has been saturated by coating material 70 and is being removed from receptacle 24 as suggested by arrow A.

Traversing opening 68 on the abutting interior surfaces of front wall 32 and back wall 42, respectively, are the mechanically-cooperating elements of closure 72. These include an elongated, resilient, female first closure element 72a on the interior surface of back wall 42 and, on the interior surface of front wall 32, an elongated, resiliently-mating, male second closure element 72b that appears only in FIG. 4.

As applicator 18 is withdrawn from receptacle 24 between first closure element 72a and second closure element 72b, applicator 18 can be rid of unwanted excess coating material 70 by imposing mutually opposed compressive forces on the outside of receptacle 24 in the vicinity of the elements of closure 72. Such exemplary compressive forces are illustrated in FIG. 4 as arrows B. Droplets of unwanted excess coating material 70 thereby squeezed or wrung from applicator 18 migrate, in a manner suggested by arrow C in FIGS. 3 and 4, toward closed end 26 of receptacle 24, there to be collected and retained for use on subsequent occasions.

According to one aspect of the present invention, a dispenser of coating material, such as dispenser 10, is provided with a barrier within the receptacle of the dispenser intermediate the closed end and the open end of the receptacle. The barrier is traversable by the coating material, thereby separating the space interior of the receptacle into a reservoir for the coating material at the closed end of the receptacle and a receiving pocket at the open end of the receptacle. Accordingly, by way of example and as shown to best advantage initially in FIG. 3, a barrier 74 extends across the interior of receptacle 24 between non-adjacent locations along attachment seal 54.

In a first embodiment of an interior construction aspect of a dispenser incorporating teachings of the present invention, a barrier, such as barrier 74, is constructed by staking together opposed portions of the walls of receptacle 24. Thus, barrier 74 includes a plurality of spaced-apart staking sites 76 at which the interior of front wall 32 is secured directly to the interior of back wall 42. If front wall 32 and back wall 42 are made in whole or in part from a thermoplastic material, staking is accomplished by thermally or ultrasonically discontinuously heat-staking front wall 32 and back wall 42 together through the exteriors thereof. If formed in this manner, barrier 74 is considered to be integrally formed with front wall 32 and back wall 42 of receptacle 24.

Arising between adjacent of staking sites 76 in barrier 74 are apertures 78 at which the interior surface of front wall 32 is free of the opposed, abutting interior surface of back wall 42. Where staking sites 76 are regularly-spaced, apertures 78 are of a single size. Alternatively, and yet within the teachings of the present invention, staking sites 76 may be irregularly-spaced, in which case apertures 78 will accordingly be of various sizes. Between seal 54 and each of the staking sites 76 at the remote ends of barrier 74 is formed a de facto aperture 78a that has a size that is not determined by the spacing of staking sites 76 within barrier 74.

The range of size appropriate in apertures 78 is governed at the lower extreme and at the upper extreme by differing considerations.

At the lower extreme, apertures 78 are large enough to permit coating material 70 to traverse barrier 74 in either direction, whether coating material 70 is a liquid as shown in FIG. 3 or a powder as will be shown elsewhere herein. This is suggested in FIG. 3 by double-ended arrows D. At the upper extreme, apertures 78 are small enough to render barrier 74 impassible to a coating material applicator, such as applicator 18, and impassable to any article that is inserted through open end 28 into receptacle 24 to be covered by coating material 70. The later situation will be illustrated and discussed subsequently herein.

Barrier 74 thus functions as a sieve capable of separating coating material 70 from applicator 18 and from any article in receptacle 24 being covered with coating material 70. In this manner, a barrier, such as barrier 74, in a dispenser incorporating teachings of the present invention separates the space within receptacle 24 into a reservoir 80 for coating material 70 at closed end 26 of receptacle 24 and a receiving pocket 82 for applicators and articles at open end 28 of receptacle 24. Reservoir 80 is so sized and configured as to comfortably house an intended supply of coating material 70, which is entered into receptacle 24 through open end 28 thereof. Thereafter, coating material 70 traverses barrier 74 to reside in reservoir 80. Receiving pocket 82 is so sized and configured as to enclose a coating material applicator, such as applicator 18, or any article that is inserted through open end 28 into receptacle 24 to be covered by coating material 70.

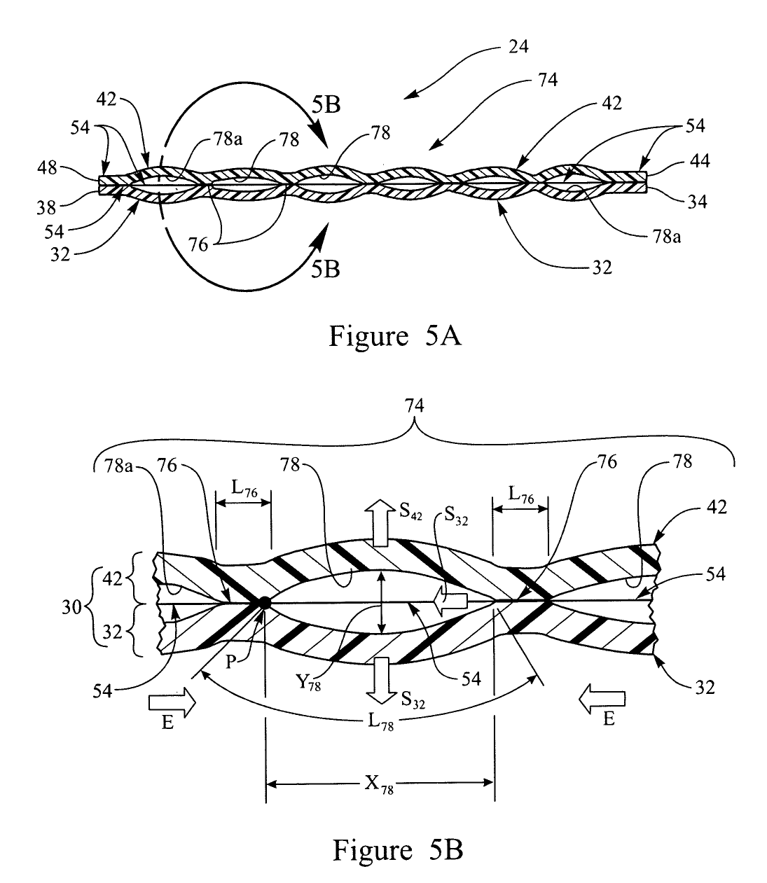

A closer examination of the structure of barrier 74 will be undertaken in relation to FIG. 5A and the enlarged view of a portion thereof presented in FIG. 5B. The point of view taken in both is through barrier 74 into reservoir 80. As staking sites 76 are substantially regularly-spaced, apertures 78 are substantially similar in size. The particular positioning of staking sites 76 employed between attachment seal 54 at each end of barrier 74 has resulted in de facto apertures 78a that are substantially similar in size to apertures 78.

As staking sites 76 are of substantially similar construction, each staking site 76 has a corresponding, substantially equal length L₇₆. Nonetheless, it is yet within the teachings of the present invention that a barrier, such as barrier 74, be constructed as needed of staking sites 76 having a plurality of distinct corresponding lengths. Staking sites of differing lengths may be arranged within barrier 74 in any sequence needed or preferred.

The physical extent of each staking site 76 is fixed once the manufacture of barrier 74 has been completed. While the sizes of apertures 78 are characterized above as being substantially similar, apertures 78 are capable of being varied individually in shape and in cross-sectional area during use, depending on the flexibility of each of front wall 32 and back wall 42 and the nature of any stresses applied to the structure of barrier 74 during use.

By way of example, typical such compressive stresses are represented in FIG. 5B by a pair of mutually-oppositely directed arrows E of equal length that are oriented generally parallel to the longitudinal extent of barrier 74. Upon manufacture, and in the absence of such stresses, the interior surface of front wall 32 abuts the opposed interior surface of back wall 42 at each aperture 78. Each aperture 78 then has a nominal length L₇₈ that is equal to the distance between staking sites 76 at the ends of aperture 78 measured along the interior surface of front wall 32 or the interior surface of back wall 42. Correspondingly, aperture 78 then exhibits no cross-sectional size whatsoever.

External forces, such as the compressive stresses represented by arrows E, produce two related forms of deformation in the walls that surround and define aperture 78. For the purpose of an analysis of those deformations, a point P at the right end of the staking site 76 in FIG. 5B between de facto aperture 78a and aperture 78 will be taken as the sole fixed point in the structure of barrier 74.

First, the compressive stresses represented by arrows E cause the staking site 76 the end of aperture 78 opposite from point P to move toward point P. Front wall 32 and back wall 42 undergoing a compressive strain S₃₂₋₄₂ that is oriented generally parallel to the longitudinal extent of barrier 74. Correspondingly, aperture 78 is compressed longitudinally, assuming an actual length X₇₈ that is less than nominal length L₇₈ of aperture 78.

Second, in accommodating compressive strain S₃₂₋₄₂, medial portions of front wall 32 between staking sites 76 bulge outwardly in a direction normal to the direction of compressive strain S₃₂₋₄₂, exhibiting a shear strain S₃₂. Medial portions of back wall 42 between staking sites 76 also bulge outwardly, but in the opposite direction, exhibiting a shear strain S₄₂. The relative amount of shear strain S₃₂ and shear strain S₄₂ depends on the relative flexibility of front wall 32 and back wall 42, respectively As a result of shear strain S₃₂ and shear strain S₄₂, the inner surfaces of front wall 32 and back wall 42 separate, no longer remaining in abutment, and aperture 78 assumes a non-zero actual width Y₇₈ measured normal to actual length X₇₈ thereof.

Consequently, aperture 78 then exhibits the positive cross-sectional area of an open passageway. When that cross-sectional area is sufficiently large, coating material 70 will traverse barrier 74 in either direction through aperture 78, depending on the gravitational orientation of receptacle 24. For fluid coating materials of low viscosity, the deformation of aperture 78 into an open passageway may not be required to enable that coating material to traverse barrier 74 in either direction through aperture 78.

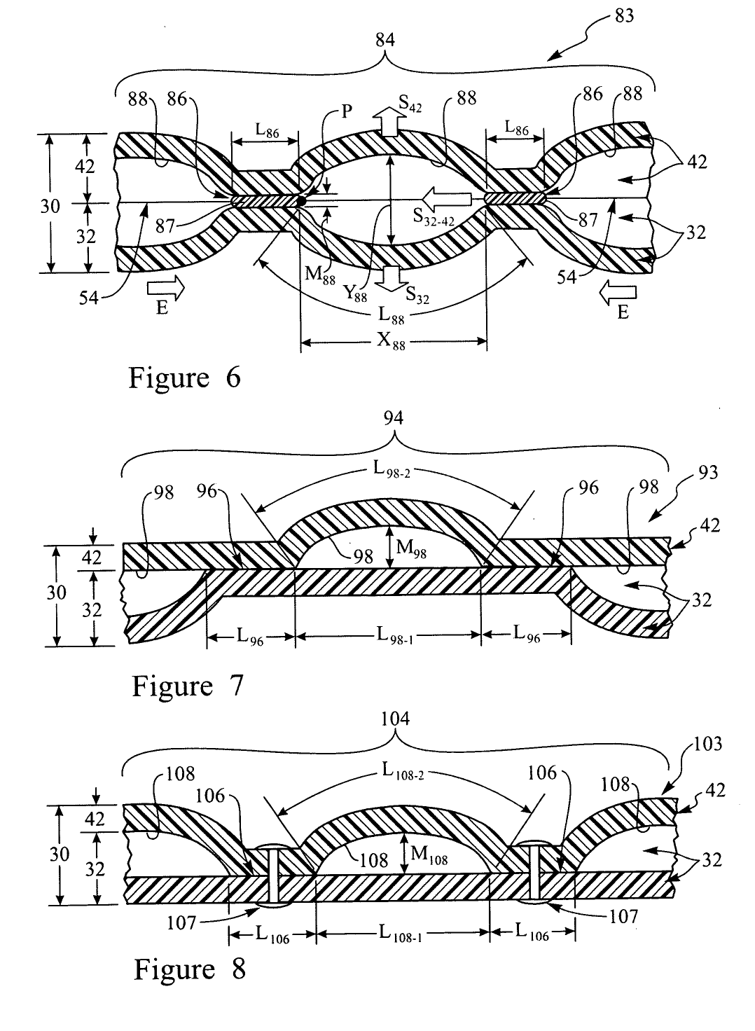

FIG. 6 is a view like that presented in FIG. 5B showing a second embodiment of an interior construction aspect of a barrier in a receptacle of a dispenser configured according to teachings of the present invention. A second embodiment of a receptacle 83 is shown to includes sidewall 30 having front wall 32 and back wall 42. A barrier 84 extends across the interior of receptacle 83 separating the space therein into a reservoir for the coating material at the closed end of receptacle 83 and a receiving pocket at the open end of receptacle 83. The point of view taken in FIG. 6 is through barrier 84 into that reservoir. Attachment seal 54 is visible between front wall 32 and back wall 42 at the bottom of the reservoir.

Barrier 84 is constructed by adhering together the interior surfaces of opposed portions of the sidewall 30 of receptacle 83. Thus, barrier 84 includes a plurality of spaced-apart adhesion sites 86 at which a quantity of an adhesive 87 is secured to and between the interior surface of front wall 32 and the interior surface of back wall 42. Adhesion sites 86 have equal associated lengths L₈₆ that correspond to the length of adhesive 87 deposited there. Nonetheless, it is yet within the teachings of the present invention that a barrier, such as barrier 84, may be constructed as needed of adhesion sites 86 that exhibit a plurality of distinct corresponding lengths. Adhesion sites of differing lengths may be arranged within barrier 84 in any sequence needed or preferred.

Each deposition of adhesive 87 has a designer-controllable, non-zero thickness that contributes to maintaining the interior surface of front wall 32 in a spaced-apart relationship relative to the interior surface of back wall 42.

Arising between adjacent adhesion sites 86 in barrier 84 are apertures 88 at which the interior surface of front wall 32 is free of the opposed interior surface of back wall 42. Where adhesion sites 86 are regularly-spaced, apertures 88 are of a single size. Alternatively, and yet within the teachings of the present invention, adhesion sites 86 may be irregularly-spaced, in which case apertures 88 will be of various sizes. The range of the size of apertures 88 is governed at the lower extreme and at the upper extreme by the differing considerations discussed above relative to barrier 74 in FIG. 5B. Thus, barrier 84 functions similarly as a sieve capable of separating a coating material from an applicator or from any article in receptacle 83 being covered with that coating material.

The physical extent of each adhesion site 76 is fixed once the manufacture of barrier 84 has been completed. While the sizes of apertures 88 are characterized above as being substantially similar, apertures 88 are capable of being varied individually in shape and in cross-sectional area during use, depending on the flexibility of each of front wall 32 and back wall 42 and the nature of the stresses applied to the structure of barrier 84 during use.

By way of example, compressive stresses are represented in FIG. 6 by a pair of mutually-oppositely directed arrows E of equal length that are oriented generally parallel to the longitudinal extent of barrier 84. Upon manufacture, and in the absence of such stresses, the opposed interior surfaces of front wall 32 and back wall 42 at aperture 88 are separated to the extent to the thickness of adhesive 87 at the ends of aperture 88. Aperture 88 then has a nominal width M₈₈ equal to the thickness of adhesive 87 and a nominal length L₈₈ that is equal to the common distance between the adhesion sites 86 at each end of aperture 88 measured along the interior surface of front wall 32 or the interior surface of back wall 42. Aperture 88 then exhibits the positive nominal cross-sectional area of an open passageway, which is approximately equal to the product of nominal width M₈₈ and nominal length L₈₈.

When external forces, such as the compressive stresses represented by arrows E, are applied to the structure of a typical aperture 88 in barrier 84, two related deformations occur in the walls that surround and define aperture 88. For the purpose of an analysis of those consequent deformations, a point P at the right end of adhesive 87 at the left adhesion site 86 in FIG. 6 will be taken as the sole fixed point in the structure of barrier 84.

First, the compressive stresses represented by arrows E cause the adhesion site 76 at the end of aperture 88 opposite from point P to move toward point P. Front wall 32 and back wall 42 undergo a compressive strain S₃₂₋₄₂ that is oriented generally parallel to the longitudinal extent of barrier 84. Correspondingly, aperture 88 is compressed longitudinally, assuming an actual length X₈₈ that is less than nominal length L₈₈ of aperture 88.

Second, in accommodating compressive strain S₃₂₋₄₂, medial portions of front wall 32 between adhesion sites 76 bulge outwardly in a direction normal to the direction of compressive strain S₃₂₋₄₂, exhibiting a shear strain S₃₂. Medial portions of back wall 42 between adhesion sites 76 bulge outwardly in the opposite direction, exhibiting a shear strain S₄₂. The relative amount of shear strain S₃₂ and shear strain S₄₂ depends on the relative flexibility of front wall 32 and back wall 42, respectively As a result of shear strain S₃₂ and shear strain S₄₂, the inner surface of front wall 32 is no longer separated from the interior surface of back wall 42 only by a distance equal to nominal width M₈₈ of aperture 88. Front wall 32 and back wall 42 bulge outwardly in opposite directions, and aperture 88 assumes an actual width Y₈₈ measured normal to actual length X₈₈ thereof that is greater than nominal width M₈₈ of aperture 88.

Aperture 88 then exhibits a positive cross-sectional area that is likely to be greater than the nominal cross-sectional area of aperture 88 set forth above. When that cross-sectional area is sufficiently large, a coating material will traverse barrier 84 in either direction through aperture 88, depending on the gravitational orientation of receptacle 83. For fluid coating materials of low viscosity and for powdered coating materials comprised of very fine particles, the deformation of aperture 88 into an enlarged, open passageway may not be necessary to permit that coating material to traverse barrier 84 in both directions through aperture 88. consequent deformations, a point P at the right end of adhesive 78 at the left adhesion site 86 in FIG. 6 will be taken as the sole fixed point in the structure of barrier 84.

First, the compressive stresses represented by arrows E cause the adhesion site 76 at the end of aperture 88 opposite from point P to move toward point P. Front wall 32 and back wall 42 undergo a compressive strain S₃₂₋₄₂ that is oriented generally parallel to the longitudinal extent of barrier 84. Correspondingly, aperture 88 is compressed longitudinally, assuming an actual length X₈₈ that is less than nominal length L₈₈ of aperture 88.

Second, in accommodating compressive strain S₃₂₋₄₂, medial portions of front wall 32 between adhesion sites 76 bulge outwardly in a direction normal to the direction of compressive strain S₃₂₋₄₂, exhibiting a shear strain S₃₂. Medial portions of back wall 42 between adhesion sites 76 bulge outwardly in the opposite direction, exhibiting a shear strain S₄₂. The relative amount of shear strain S₃₂ and shear strain S₄₂ depends on the relative flexibility of front wall 32 and back wall 42, respectively As a result of shear strain S₃₂ and shear strain S₄₂, the inner surface of front wall 32 is no longer separated from the interior surface of back wall 42 only by a distance equal to nominal width M₈₈ of aperture 88. Front wall 32 and back wall 42 bulge outwardly in opposite directions, and aperture 88 assumes an actual width Y₈₈ measured normal to actual length X₈₈ thereof that is greater than nominal width M₈₈ of aperture 88.

Aperture 88 then exhibits a positive cross-sectional area that is likely to be greater than the nominal cross-sectional area of aperture 88 set forth above. When that cross-sectional area is sufficiently large, a coating material will traverse barrier 84 in either direction through aperture 88, depending on the gravitational orientation of receptacle 83. For fluid coating materials of low viscosity and for powdered coating materials comprised of very fine particles, the deformation of aperture 88 into an enlarged, open passageway may not be necessary to permit that coating material to traverse barrier 84 in both directions through aperture 88.

FIG. 7 is a view like that presented in FIG. 5B showing a third embodiment of an interior construction aspect of a barrier in a receptacle of a dispenser configured according to teachings of the present invention. A third embodiment of a receptacle 93 is shown to include sidewall 30 having front wall 32 and back wall 42. A barrier 94 extends across the interior of receptacle 93 separating the space therein into a reservoir for the coating material at the closed end of receptacle 93 and a receiving pocket at the open end of receptacle 93. The point of view taken in FIG. 7 is through barrier 94 into that reservoir.

Barrier 94 is constructed by alternate-side offset-staking together the interior surfaces of opposed portions of sidewall 30 of receptacle 93. Thus, barrier 94 includes a plurality of spaced-apart staking sites 96 at which the interior surface of front wall 32 is secured directly to the interior surface of back wall 42, whereby barrier 94 is considered to be integrally formed with front wall 32 and back wall 42 of receptacle 24. Staking is accomplished by thermally or ultrasonically discontinuously heat-staking front wall 32 and back wall 42 together through the exteriors thereof.

Staking sites 96 have equal associated lengths L₉₆. Nonetheless, it is yet within the teachings of the present invention that a barrier, such as barrier 94, be constructed as needed of staking sites 96 having a plurality of distinct corresponding lengths. Staking sites of differing lengths may be arranged within barrier 94 in any sequence needed or preferred.

One of the opposed the walls of receptacle 93 between each adjacent pair of staking sites 96 is longer than the other of the opposed walls between that same adjacent pair of staking sites 96. This in FIG. 7, the portion of back wall 42 between the pair of staking sites 96 shown is longer than the portion of front wall 32 between that same pair of staking sites 96. This causes back wall 42 between the pair of adjacent staking sites 96 to bulge outwardly, away from front wall 32. To either side of this portion of barrier 94 this relative relationship between the lengths of the opposed the walls of receptacle 93 is reversed. Thus, the portion of front wall 32 between staking sites 96 shown in FIG. 7 and the next adjacent staking site 96 in barrier 94, which is beyond the edges of FIG. 7, is longer than the corresponding portion of back wall 42. This causes back wall 42 to bulge outwardly, away from back wall 42. This arrangement is characteristic of alternate-side offset-staking.

Arising between adjacent of staking sites 96 of barrier 94 are apertures 98 at which the interior surface of front wall 32 is free of the opposed interior surface of back wall 42. Where staking sites 96 are regularly-spaced, apertures 98 are of a single size. Alternatively, and yet within the teachings of the present invention, staking sites 96 may be irregularly-spaced, in which case apertures 98 will accordingly be of various sizes. The range of the size of apertures 98 is governed at the lower and upper extremes by the differing considerations discussed above relative to barrier 74 in FIG. 5B. Barrier 94 thus similarly functions as a sieve capable of separating a coating material from an applicator or from any article in receptacle 93 being covered with that coating material.

The physical extent of each staking site 96 is fixed once the manufacture of barrier 94 has been completed. While the sizes of apertures 98 are characterized above as being substantially similar, apertures 98 are capable of being varied individually in shape and in cross-sectional area during use, depending on the nature of stresses applied to the structure of barrier 94 during use and the flexibility of each of front wall 32 and back wall 42. In view of the earlier discussion of the effects of typical of such stresses on to the structures shown in FIGS. 5B and 6, those effects will not be explored relative to barrier 94.

Upon manufacture, and in the absence of such stresses, each aperture 98 has a first nominal length L₉₈₋₁ that is equal to the distance between the staking sites 96 at each end of aperture 98 measured along the interior surface of the shorter of the opposed walls of receptacle 93 between that same adjacent pair of staking sites 96. As first nominal length L₉₈₋₁ of aperture 98 is less than the second nominal length L₉₈₋₂ of aperture 98 measured along the interior surface of the longer of the opposed walls of receptacle 93 between those same adjacent pair of staking sites 96, one side of aperture 98 bulges outwardly, and each aperture 98 exhibits a nominal width M₉₈. Aperture 98 correspondingly then has a positive nominal cross-sectional area that is somewhat less than the product of nominal width M₉₈ and first nominal length L₉₈₋₁. When that cross-sectional area is sufficiently large, a chosen coating material will traverse barrier 94 through aperture 98 in both directions.

FIG. 8 is a view like that presented in FIG. 5B showing a fourth embodiment of an interior construction aspect of a barrier in a receptacle in a dispenser configured according to teachings of the present invention. A fourth embodiment of a receptacle 103 is shown to include sidewall 30 having front wall 32 and back wall 42. A barrier 104 extends across the interior of receptacle 103 separating the space therein into a reservoir for the coating material at the closed end of receptacle 103 and a receiving pocket at the open end of receptacle 103. The point of view taken in FIG. 8 is through barrier 104 into that reservoir.

Barrier 104 is constructed by the same-side offset-securing together of opposed portions of sidewall 30 of receptacle 103. Thus, barrier 104 includes a plurality of spaced-apart securement sites 106 at which front wall 32 is secured to back wall 42. As shown by way of example, the securement of front wall 32 and back wall 42 at securement sites 106 is effected using a rivet 107 that passes through front wall 32 and back wall 42 at securement site 106 and urges the interior surface there of front wall 32 into sealing engagement with the interior surface of back wall 42.

Securement sites 106 have equal associated lengths L₁₀₆, a dimension determined primarily by the configuration of rivet 107. Nonetheless, it is yet within the teachings of the present invention that a barrier, such as barrier 104, may be constructed as needed of securement sites 106 having a plurality of distinct corresponding lengths determined by the distinct particular size of the rivet at each securement site. Securement sites of differing lengths may be arranged within barrier 104 in any sequence needed or preferred.

Back wall 42 of receptacle 93 between each adjacent pair of securement sites 106 is longer than front wall 32 between that same pair of securement sites 106. Thus, in FIG. 8, the portion of back wall 42 between the pair of securement sites 106 shown is longer than the portion of front wall 32 between that pair of securement sites 106. This causes back wall 42 between that pair of securement sites 106 to bulge outwardly, away from front wall 32. To either side of this portion of barrier 104 this relative size relationship between the opposed walls of receptacle 93 between each adjacent pair of securement sites 106 is maintained. Thus, the portion of back wall 42 between securement sites 106 shown in FIG. 8 and the next adjacent securement site 106 of barrier 104, which is beyond the edges of FIG. 8, is longer than the corresponding portion of front wall 32. This arrangement is characteristic of same-side offset-securement.

Arising between adjacent securement sites 106 in barrier 104 are apertures 108 at which the interior surface of front wall 32 is free of the opposed interior surface of back wall 42. Where securement sites 106 are regularly-spaced, apertures 108 are of a single size. Alternatively, and yet within the teachings of the present invention, securement sites 106 may be irregularly-spaced, in which case apertures 108 will accordingly be of various sizes. The range of the size of apertures 108 is governed at the lower and upper extremes by the differing considerations discussed above relative to barrier 74 in FIG. 5B. Thus, barrier 104 functions as a sieve capable of separating a coating material from an applicator or from any article in receptacle 103 being covered with that coating material.

The physical extent of each securement site 106 is fixed once the manufacture of barrier 104 has been completed. While the sizes of apertures 108 are characterized above as being substantially similar, apertures 108 are capable of being varied individually in shape and in cross-sectional area during use, depending on the nature of the stresses applied to the structure of barrier 104 during use and the flexibility of each of front wall 32 and back wall 42. In view of the earlier discussion of the effects of typical of such stresses relative to the structures shown in FIGS. 5B and 6, those effects will not be explored relative to barrier 104.

Upon manufacture, and in the absence of such stresses, each aperture 108 has a first nominal length L₁₀₈₋₁ that is equal to the distance between the securement sites 106 at each end of aperture 108 measured along the interior surface of front wall 32, the shorter of the opposed walls of receptacle 103 between that same pair of securement sites 106. As first nominal length L₁₀₈₋₁ of aperture 108 is less than the second nominal length L₁₀₈₋₂ of aperture 108 measured along the interior surface of back wall 42, the longer of the opposed walls of receptacle 103 between that same adjacent pair of staking sites 106 bulges outwardly, and aperture 108 exhibits a nominal width M₁₀₈. Aperture 98 correspondingly exhibits a positive nominal cross-sectional area that is somewhat less than the product of nominal width M₁₀₈ and first nominal length L₁₀₈₋₁. When that cross-sectional area is sufficiently large, a chosen coating material will traverse barrier 104 through aperture 108 in either direction.

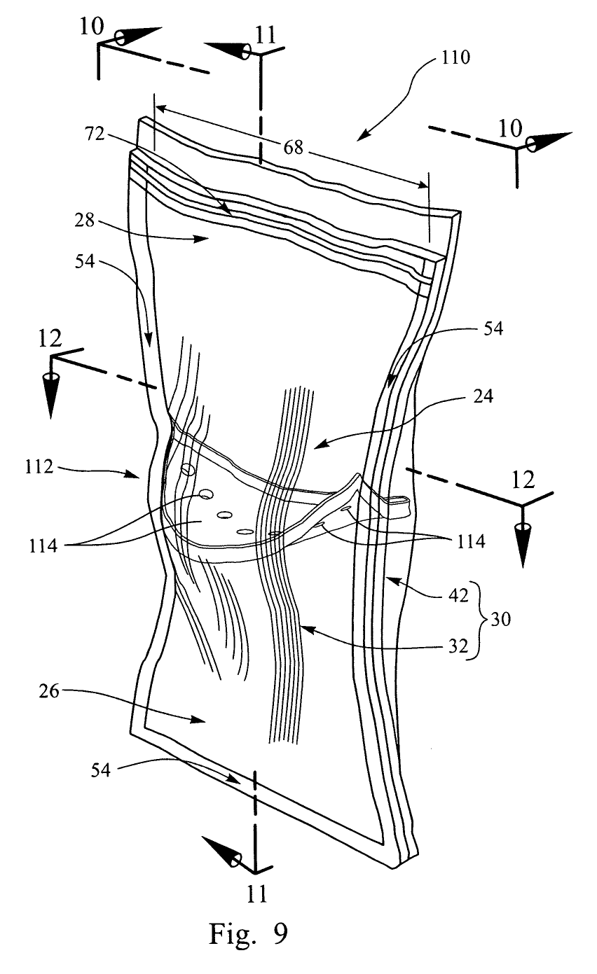

FIG. 9 is a perspective view of a second embodiment of a dispenser 110 of coating material incorporating teachings of the present invention. Dispenser 110 assumes the form of receptacle 24 with closed end 26 and open end 28 remote therefrom. Receptacle 24 includes encircling sidewall 30 that has front wall 32 and back wall 42. A continuous attachment seal 54 is created between front wall 32 and back wall 34 along a contiguous series of respective edges of each. Access to the interior of receptacle 24 is afforded by way of opening 68 between the ends of attachment seal 54. Selectively resealable closure 72 is provided at opening 68.

A barrier that is traversable by a coating material, but impassible to an applicator of the coating material or an article being covered with the coating material, extends across the interior of receptacle 24 between non-adjacent locations along attachment seal 54. The barrier takes the form of a flexible perforated gusset 112 that is attached about the periphery thereof to front wall 32 and back wall 42 of receptacle 24. The portion of dispenser 110 interposed between gusset 112 and a viewer of FIG. 9 is transparent, whereby it is possible to observe that formed through gusset 112 is a plurality of apertures 114. The entirety of dispenser 110 may be similarly transparent in whole or in part. Alternatively, dispenser 110 may be translucent or opaque in whole or in part without departing from teachings of the present invention.

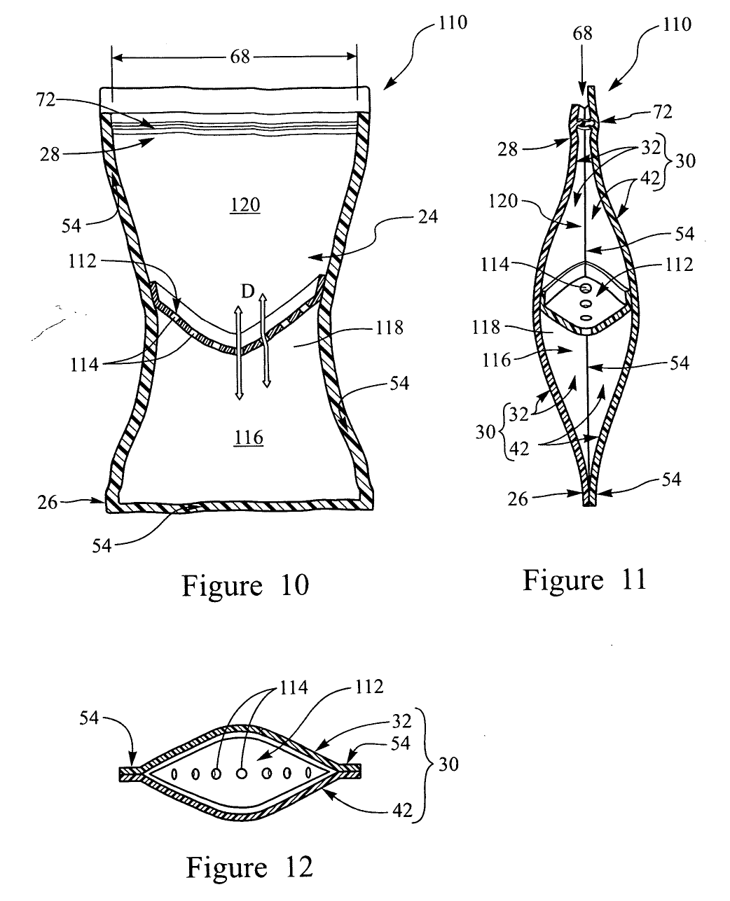

The interior structure of receptacle 24 of dispenser 110 will be explored further by reference to the cross-sectional views of receptacle 24 presented in FIGS. 10-12 taken together.

The range of the size apertures 114 in gusset 112 is governed at the lower and upper extremes by differing considerations. Apertures 114 are large enough to permit a coating material, be it a liquid as shown in FIG. 3 or a powder as shown elsewhere herein, to traverse gusset 112 in either direction. This is suggested in FIG. 10 by double-ended arrows D. On the other hand, apertures 114 are small enough to render gusset 112 impassible to a coating material applicator and to an article that is inserted through opening 68 and into receptacle 24 there to be covered by the coating material. The later situation will be illustrated and discussed subsequently herein. Thus, gusset 112 functions as a sieve capable of separating the coating material from an applicator and from any article in receptacle 24 being covered with the coating material.

According to one perspective, a dispenser for a coating material, such as dispenser 110, includes a lower compartment 116 having an open upper end 118 and a closed lower end, which in FIGS. 10-12 is coincident with closed end 26 of receptacle 24. An upper compartment 120 communicates with lower compartment 116 through upper end 118 thereof, and has a selectively resealable upper end remote from lower compartment 116 that is coincident with open end 28 of receptacle 24. Gusset 112 is interposed between upper compartment 120 and lower compartment 116 across upper end 118 thereof.

Lower compartment 116 is so sized and configured as to house an intended supply of a coating material, which is placed in receptacle 24 through open end 28 thereof and then traverses gusset 112 to reach lower compartment 116. Upper compartment 120 is so sized and configured as to enclose a coating material applicator or an article that is inserted into open end 28 of receptacle 24 and there covered by the coating material from lower compartment 116. The later situation will be illustrated and discussed subsequently herein.

Upper compartment 120 and lower compartment 116 together from a tubular structure with thin sidewalls and a closed end opposite from the upper end of upper compartment 120. When constructed of suitable flexible sidewalls, upper compartment 120 is collapsible against an applicator for the coating material, whereby excess coating material can be wrung from the applicator preparatory to removing the applicator from upper compartment 120 through the upper end thereof.

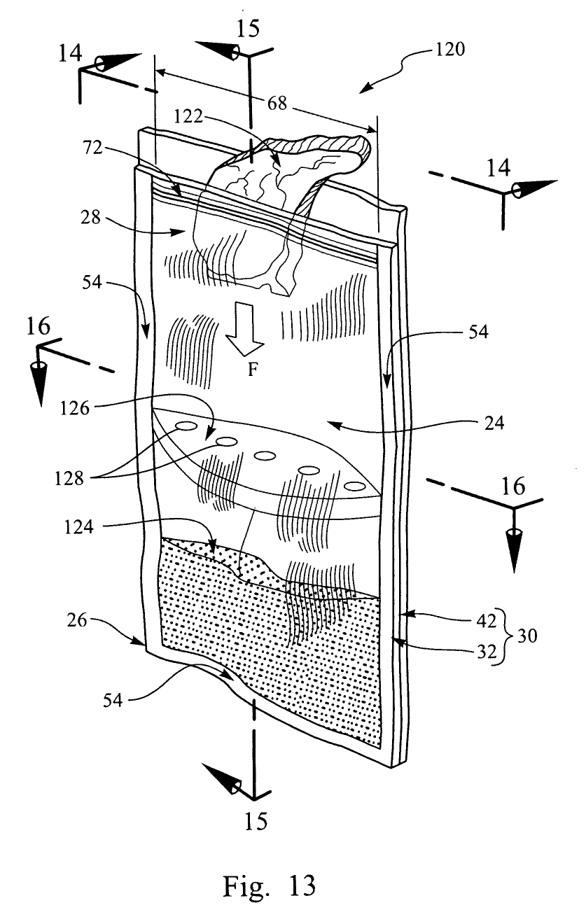

FIG. 13 is a perspective view of a third embodiment of a dispenser 120 of coating material incorporating teachings of the present invention. As suggested by arrow F, a cut of meat 122 is in the process of entering dispenser 120 there to be cover prior to cooking by a dry rub application of a powdered coating material that is contained in dispenser 120. The portion of dispenser 120 interposed between and a viewer of FIG. 13 and meat 122 is transparent, whereby it is possible to observe the portion of meat 122 that is within dispenser 120, as well as a quantity of a spice mixture 124 with which it is intended to cover meat 122. The entirety of dispenser 120 may be similarly transparent in whole or in part. Alternatively, dispenser 120 may be translucent or opaque in whole or in part without departing from teachings of the present invention.

Dispenser 120 takes the form of rectangular receptacle 24 with closed end 26 and open end 28 remote therefrom. Receptacle 24 includes continuous encircling sidewall 30 that has front wall 32 and back wall 42. A continuous attachment seal 54 is created between front wall 32 and back wall 34 along a contiguous series of respective edges of each. Access to the interior of receptacle 24 is afforded by way of opening 68 between the ends of attachment seal 54. Selectively resealable closure 72 is provided at opening 68.

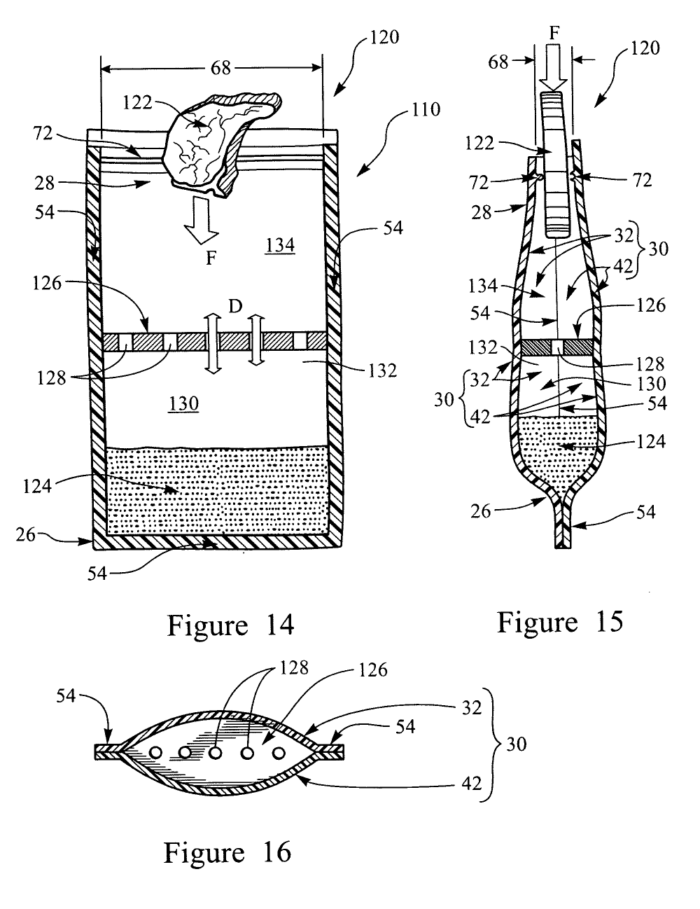

A barrier that is traversable by spice mixture 124, but that is impassible to meat 122, extends across the interior of receptacle 24 between non-adjacent locations along attachment seal 54. The barrier takes the form of a rigid perforated gusset 126 that is attached about the periphery thereof to front wall 32 and back wall 42 of receptacle 24. Formed through gusset 126 is a plurality of apertures 128. The interior structure of receptacle 24 of dispenser 120 will be explored further by reference to the cross-sectional views of receptacle 24 presented in FIGS. 14-16 taken together.

Apertures 128 in gusset 126 are large enough to permit spice mixture 124 to traverse gusset 126 in either direction. This is suggested in FIG. 14 by double-ended arrows D. On the other hand, apertures 128 are small enough to render gusset 112 impassible to meat 122. Thus, gusset 126 functions to allow spice mixture 124 to reach meat 122, once meat 122 is enclosed in dispenser 120 and dispenser 120 is sealed at closure 76 and inverted. When dispenser 120 is returned to the upright orientation thereof shown in FIG. 14, gusset 126 permits excess spice mixture 124 to fall from meat 122 through apertures 128 to be retained in dispenser 120 for use on a subsequent occasion. Closure 76 is opened, and meat 122 covered with spice mixture 124 is removed from dispenser 120 through opening 68.

Thus dispenser 120 includes a lower compartment 130 having an open upper end 132 and a closed lower end, which in FIGS. 14-16 is coincident with closed end 26 of receptacle 24. An upper compartment 134 communicates with lower compartment 130 through upper end 132 thereof, and has a selectively resealable upper end remote from lower compartment 116 that is coincident with open end 28 of receptacle 24. Gusset 126 is interposed between upper compartment 134 and lower compartment 130 across upper end 132 thereof.

Lower compartment 130 is so sized and configured as to house an intended supply of spice mixture 124, which is placed in receptacle 24 through open end 28 thereof and then traverses gusset 126 to reach lower compartment 130. Upper compartment 134 is so sized and configured as to enclose meat 122.

Upper compartment 134 and lower compartment 130 together from a tubular structure with a closed end opposite from the upper end of upper compartment 134. When constructed of suitable flexible sidewalls, upper compartment 134 is collapsible against meat 122, whereby spice mixture 124 can be urged into the surface of meat 122 preparatory to removing meat 122 from upper compartment 120 through opening 68.

Typically, for circumstances such as those served by dispenser 120 in FIG. 13, front wall 32 and back wall 42 of sidewall 30 of receptacle 24 are made from polyethylene sheeting of about 0.04 millimeters in thickness and are about 10.0 inches wide and 12.0 inches tall. Gusset 126 is installed in receptacle 24 about 5.0 inches from closed end 26 thereof.

The foregoing description of the present invention has been provided to enhance clarity and to promote understanding and is not intended to limit the present invention to the precise form or forms disclosed. Various modifications to the disclosed embodiments are possible without departing from the scope and equivalence correctly attributable to the appended claims.

What is claimed is:

1. A dispenser for a coating material, said dispenser comprising:
(a) a receptacle having a closed end and an open end remote therefrom;
(b) a selectively resealable closure at said open end of said receptacle; and
(c) a barrier within said receptacle intermediate said closed end and said open end thereof, said barrier being traversable by the coating material and thereby separating said receptacle into a reservoir for the coating material at said closed end of said receptacle and a receiving pocket at said open end of said receptacle.

2. A dispenser as recited in claim 1, wherein said receiving pocket is so sized and configured as to enclose an article to be covered in the coating material.

3. A dispenser as recited in claim 1, wherein said receiving pocket is so sized and configured as to enclose an applicator of the coating material.

4. A dispenser as recited in claim 1, wherein said coating material is a liquid.

5. A dispenser as recited in claim 1, wherein said coating material is a powder.

6. A dispenser as recited in claim 1, wherein said receptacle comprises a continuous, encircling sidewall extending between said closed end and said open end of said receptacle.

7. A dispenser as recited in claim 6, wherein said barrier is integrally formed with said sidewall of said receptacle.

8. A dispenser as recited in claim 7, wherein said barrier is formed by discontinuous staking together of opposed portions of said sidewall of said receptacle.

9. A dispenser as recited in claim 7, wherein said barrier comprises a perforated gusset attached about the periphery thereof to said sidewall of said receptacle.

10. A dispenser as recited in claim 6, wherein said closure comprises opposed elongated resilient mechanically-mating structures on the interior of said sidewall of said receptacle at said open end thereof.

11. A dispenser for a coating material, said dispenser comprising:
(a) a lower compartment having an open upper end;
(b) an upper compartment communicating with said lower compartment through said upper end thereof, said upper compartment having a selectively resealable upper end remote from said lower compartment; and
(c) a sieve interposed between said upper compartment and said lower compartment across said upper end of said lower compartment, said sieve being traversable by the coating material.

12. A dispenser as recited in claim 11, wherein:
(a) said upper compartment is so sized and configured as to enclose an article to be covered in the coating material; and
(b) said sieve is impassible to the article to be covered in the coating material.

13. A dispenser as recited in claim 11, wherein:
(a) said upper compartment is so sized and configured as to enclose an applicator for the coating material; and
(b) said sieve is impassible to the applicator for the coating material.

14. A dispenser as recited in claim 13, wherein said upper compartment is collapsible against the applicator for the coating material, whereby excess coating material can be wrung from the applicator preparatory to removing the applicator from said upper compartment through said upper end thereof.

15. A dispenser as recited in claim 11 wherein:
(a) said upper compartment is secured directly to said lower compartment; and
(b) said upper compartment and said lower compartment together from a tubular structure with thin sidewalls and a closed end opposite from said upper end of said upper compartment.

16. A dispenser as recited in claim 15, wherein:
(a) said tubular structure is comprised of a thermoplastic material; and
(b) said sieve is formed by discontinuously staking together opposed portions of said sidewalls of said tubular structure.

17. A dispenser for a coating material, said dispenser comprising:
(a) a flexible front wall;
(b) a flexible back wall continuously sealed to said front wall along a contiguous series of edges of said front wall and said back wall, said contiguous series of edges terminating in spaced-apart ends defining there between an opening into an interior space between said front wall and said back wall;
(b) a selectively resealable closure at said opening; and
(d) a barrier within said interior space interconnecting said front wall and said back wall, said barrier being traversable by the coating material and thereby separating said interior space into a receiving pocket adjacent said closure and a reservoir for the coating material on the opposite side of said barrier from said receiving pocket.

18. A dispenser as recited in claim 17, wherein:
(a) said front wall and said back wall are rectangular; and
(b) said opening is located along a shared edge of said front wall and said back wall.

19. A dispenser as recited in claim 17, wherein said barrier is formed by discontinuous staking portions of said front wall to correspondingly opposed portions of said back wall.

20. A dispenser as recited in claim 17, wherein said barrier comprises a sieve secured between said front wall and said back wall.
